(19) United States
(12) Patent Application Publication
(10) Pub. No.: US 2022/0168980 A1
(43) Pub. Date: Jun. 2, 2022

(54) SYSTEM FOR MANUFACTURING A SUPPORT STRUCTURE

(71) Applicant: The Goodyear Tire & Rubber Company, Akron, OH (US)

(72) Inventors: Ceyhan Celik, Stow, OH (US); Steven Amos Edwards, Akron, OH (US); Michael Scott Deem, Kent, OH (US); Michael James Hogan, Tallmadge, OH (US); Arun Kumar Byatarayanapura Gopala, Copley, OH (US); George Michael Stoila, Tallmadge, OH (US); James Alfred Benzing, II, North Canton, OH (US)

(21) Appl. No.: 17/109,901

(22) Filed: Dec. 2, 2020

(51) Int. Cl. B29D 30/02; B60C 7/14; B60C 7/10; B29C 33/40; B29C 41/04

(52) U.S. Cl. CPC B29D 30/02; B60C 7/14; B60C 2007/107; B29C 33/405; B29C 41/047; B60C 7/102

(57) ABSTRACT

A system cures and manufactures a partially-cured tire assembly. The system includes an annular hub member slid into a corresponding annular, radially inner surface, a plurality of elongate spacer members for maintaining corresponding uniform cavity dimensions by fastening the spacer members to the hub member with flap members thereby enclosing a radially outermost surface of each of the spacer members, a first annular curing platen for axially securing the hub member and spacer members relative to each other, a second annular curing platen for axially securing the hub member and spacer members relative to each other; and a plurality of elongate inserts.

### FIELD OF INVENTION

The present invention relates to wheel/tire assemblies, and more particularly, to a system for manufacturing non-pneumatic wheel/tire assemblies.

### BACKGROUND OF THE INVENTION

Radial pneumatic tires rely on the ply reinforcement to carry and transfer the load between the rim and the belt layer. These ply cords need to be tensioned to carry the load. Tensioning of these ply cords is achieved with the pressurized air in the inner chamber of the tire. If air pressure is lost, load carrying capacity of a pneumatic tire decreases significantly. Preventing the slow or sudden air pressure loss has been a challenge for the tire makers. One proposed solution is to use non-pneumatic tires. A top loader non-pneumatic tire can perform similar to a pneumatic tire if its durability, speed rating/limit and load capacity can be increased to the levels of a pneumatic tire.

Many top loader non-pneumatic tires rely on the polymeric spokes to carry the load of the vehicle. Spokes transfer the load from the rim to the shear band. Due to the characteristics of the polymeric materials used in the spokes of these tires, performance of these tires is limited. It is an object of the present invention to overcome this limitation and increase the load carrying capacity and durability of these spokes and hence the performance of the top loader non-pneumatic tire.

### Definitions

As used herein and in the claims:

“Annular” means formed like a ring.

“Axial” and “axially” refer to lines or directions that are parallel to the axis of rotation of the tire.

“Circumferential” and “circumferentially” mean lines or directions extending along the perimeter of the surface of the annular tire parallel to the equatorial plane (EP) and perpendicular to the axial direction; it can also refer to the direction of the sets of adjacent circular curves whose radii define the axial curvature of the tread, as viewed in cross section.

“Equatorial plane (EP)” means the plane perpendicular to the tire's axis of rotation and passing through the center of its tread; or the plane containing the circumferential centerline of the tread.

“Inner” means toward the inside of the tire and “outer” means toward its exterior.

“Lateral” means an axial direction.

“Normal load” means the load assigned by the appropriate standards organization for the service condition for the tire.

“Radial” and “radially” mean directions radially toward or away from the axis of rotation of the tire.

“Spring rate” means the stiffness of tire expressed as the slope of the load deflection curve at a given pressure.

“Tread” means a molded rubber component which, when bonded to a tire casing, includes that portion of the tire that comes into contact with the road when the tire is normally inflated and under normal load.

“Tread element” or “traction element” means a rib or a block element.

“Tread width” means the arc length of the tread surface in a plane including the axis of rotation of the tire.

“Vertical deflection” means the amount that a tire deflects under load.

“Wheel” or “hub” means a structure for supporting the tire and mounting to the vehicle axle.

### SUMMARY OF THE INVENTION

A system in accordance with the present invention cures and manufactures a partially-cured tire assembly. The system includes an annular hub member slid into a corresponding annular, radially inner surface of the partially-cured tire assembly, a plurality of elongate spacer members for maintaining corresponding uniform cavity dimensions in the partially-cured tire assembly tire assembly by fastening the spacer members to the hub member with flap members of the partially-cured tire assembly tire assembly thereby enclosing a radially outermost surface of each of the spacer members, a first annular curing platen for axially securing the hub member and spacer members relative to each other, a second annular curing platen for axially securing the hub member and spacer members relative to each other; and a plurality of elongate inserts for creating a substantially smooth, uniform outer cylindrical surface formed by a radially outer surface of each insert and flap members of the tire assembly positioned by the radially outermost surfaces of the spacer members.

According to another aspect of the system, a plurality of mold members is placed circumferentially around a radially outer surface of a tread member.

According to still another aspect of the system, radially inner surfaces of the mold members together form a tread shaped outer surface in the radially outer surface of the tread member.

According to yet another aspect of the system, the spacer members, first and second curing platens, triangular inserts, and mold members are heated in order to cure form the flap members, a shear band, and a tread member into a molded integral part of a complete, cured tire assembly.

According to still another aspect of the system, the elongate inserts have a triangular cross-section.

According to yet another aspect of the system, the mold members are radially removable from around the complete, cured tire assembly.

According to still another aspect of the system, the curing platens are axially removable from the hub member, the elongate spacer members, and elongate inserts.

According to yet another aspect of the system, the curing platens are heated by a hot liquid.

According to still another aspect of the system, the elongate spacer members platens are heated by steam.

According to yet another aspect of the system, the elongate inserts are heated by electricity.

A method in accordance with the present invention completes the curing of a partially cured tire assembly. The method includes the steps of: sliding an annular hub member into a corresponding annular, radially inner surface of the partially-cured tire assembly; maintaining a plurality of spacer members within corresponding uniform cavities in the partially-cured tire assembly; fastening the spacer members to the hub member with uncured flap members of the partially-cured tire assembly enclosing a radially outermost surface of each of the spacer members; axially securing first and second curing platens, the hub member, and spacer members relative to each other; and creating a substantially smooth, uniform outer cylindrical surface formed by a radially outer surface of each spacer member and each of the uncured flap members of the partially-cured tire assembly positioned by the radially outermost surfaces of the spacer members.

According to another aspect of the method, a further step includes serially placing an uncured inner annular shear band and an uncured outer annular tread member of the partially-cured tire assembly circumferentially around the uniform outer cylindrical surface.

According to still another aspect of the method, a further step includes affixing the uncured inner annular shear band and the uncured outer annular tread member of the partially-cured tire assembly to each other.

According to yet another aspect of the method, a further step includes placing a plurality of mold members circumferentially around a radially outer surface of the tread member.

According to still another aspect of the method, a further step includes forming a tread shaped outer surface in the outer surface of the tread member by radially inner surfaces of the mold members.

According to yet another aspect of the method, a further step includes heating the spacer members, curing platens, elongate inserts, and mold members in order to form the flap members, shear band, and tread member into a fully-cured tire assembly.

According to still another aspect of the method, a further step includes radially removing the mold members from around the fully-cured tire assembly.

According to yet another aspect of the method, a further step includes axially removing the curing platens from the hub member.

According to still another aspect of the method, a further step includes axially withdrawing the spacer members and inserts from the fully-cured tire assembly to reveal stable cavities within a spoke structure of a rim-mountable, fully-cured tire assembly.

According to yet another aspect of the method, the heating step includes a medium from the group consisting of a hot liquid, steam, and electricity.

### BRIEF DESCRIPTION OF THE DRAWINGS

The present invention will be more clearly understood by the following description of some examples thereof, with reference to the accompanying drawings, in which:

FIG. 1 is a schematic perspective view of a part of an example wheel/tire assembly in accordance with the present invention;

FIG. 2 is another schematic perspective view of part of the assembly of FIG. 1;

FIG. 3 is a schematic perspective view of another part of the assembly of FIG. 1;

FIG. 4 is a schematic perspective view of yet another part of the assembly of FIG. 1;

FIG. 5 is a schematic perspective view of still another part of the assembly of FIG. 1;

FIG. 6 is a schematic perspective view of yet another part of the assembly of FIG. 1;

FIG. 7 is a schematic perspective view of still another part of the assembly of FIG. 1;

FIG. 8 is a schematic perspective view of yet another part of the assembly of FIG. 1;

FIG. 9 is an exploded schematic perspective view of still another part of the assembly of FIG. 1;

FIG. 10 is a schematic perspective view of yet another part of the assembly of FIG. 1;

FIG. 11 is a schematic perspective view of still another part of the assembly of FIG. 1;

FIG. 12 is a schematic perspective view of yet another part of the assembly of FIG. 1;

FIG. 13 is a schematic perspective view of still another part of the assembly of FIG. 1;

FIG. 14 is a schematic perspective view of yet another part of the assembly of FIG. 1;

FIG. 15 is a schematic perspective view of still another part of the assembly of FIG. 1;

FIG. 16 is a schematic perspective view of yet another part of the assembly of FIG. 1;

FIG. 17 is a schematic perspective view of still another part of the assembly of FIG. 1;

FIG. 18 is an exploded schematic perspective view of yet another part of the assembly of FIG. 1;

FIG. 19 is a schematic perspective view of still another part of the assembly of FIG. 1;

FIG. 20 is a schematic perspective view of yet another part of the assembly of FIG. 1;

FIG. 21 is a schematic perspective view of still another part of the assembly of FIG. 1; and

FIG. 22 is a schematic flow chart of an example method in accordance with the present invention.

### DESCRIPTION OF EXAMPLES OF THE PRESENT INVENTION

A conventional wheel/tire assembly may have an outer ring, such as a shear band, flexibly connected to a central hub by means of lightweight composite springs. The springs may be plates fixed to the ring and to the hub. The hub may contain a speed reduction gear unit and/or an electric motor and may have a suspension mechanism for connecting a vehicle chassis to each wheel. The ring may be constructed from a flexible composite material, such as carbon fiber reinforced nylon material and have twin rubber tires and a plurality of circumferentially spaced-apart radial cleats which engage the ground and provide improved traction. The hub may also be formed from a carbon fiber reinforced composite material. Another conventional wheel may have a rubber strip with a molded tread bonded to a composite ring for improved grip. Further, the springs interconnecting the ring and hub may be S-shaped lightweight composite springs.

Another conventional wheel/tire assembly may be formed from a lightweight composite material, such as carbon fiber reinforced polyamide. The assembly may have a cylindrical central hub and a circular outer flexible rim mounted on the central hub by an endless looped spring band extending between the central hub and the circular rim. Six radial loops may be defined by the spring band. The spring band may be attached to the central hub and to the circular rim by any suitable means, such as adhesion, cohesion, soldering and/or mechanical fixing by means of bolts, rivets, and/or clamps.

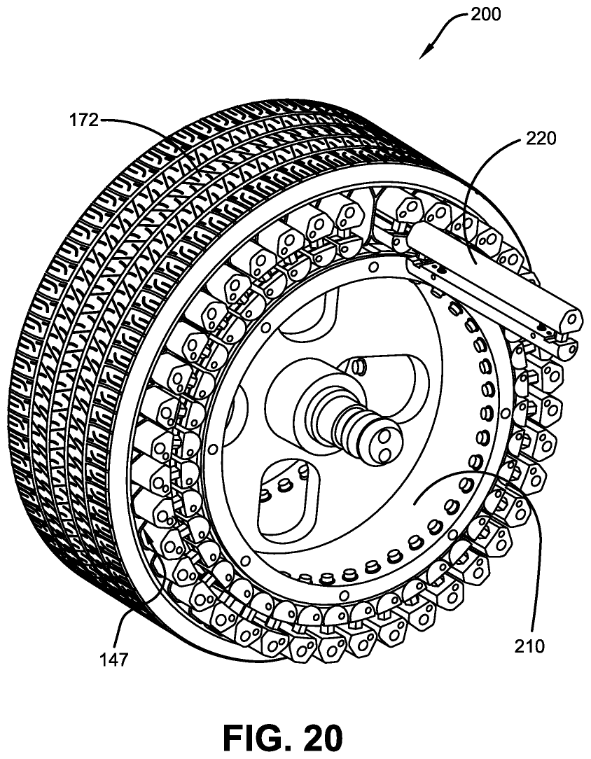

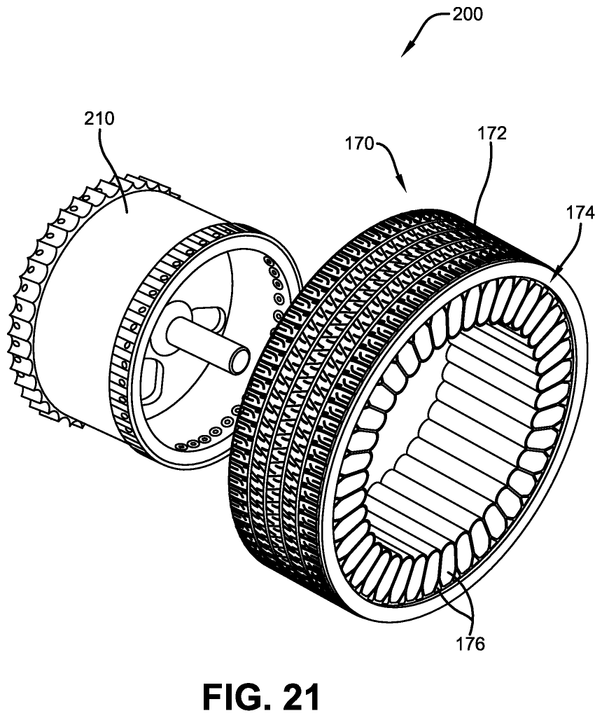

As shown in FIGS. 20-21, an example tire assembly, such as that described in Applicant's U.S. Pat. No. 10,207,544, incorporated herein by reference in its entirety, may be formed from a lightweight polymer material, such as, for example, a standard tire rubber compound, a thermoplastic polymer, polyethylene terephthalate (PET), polyether ether ketone (PEEK), a cross-linking polymer like natural rubber, synthetic rubber-like polymers, epoxy resins, and/or phenolic resins. The assembly may have an inner central rim, such as an automobile wheel (not shown), and a circular outer flexible ring, which may include a shear band and tread structure, mounted on the inner central rim by a continuous cord/fabric reinforced spoke structure extending between the inner central rim and the outer ring.

The spoke structure may define a plurality of cavities disposed concentrically about the inner central rim allowing the spoke structure to deflect under load thereby defining a suitable balance between flexibility for ride comfort and traction within a footprint of the assembly and stiffness for vehicle handling, low rolling resistance, and low heat build-up within the spoke structure. The cavities of the spoke structure may further define openings for arms of the inner central rim to extend therethrough and secure the spoke structure to the inner central rim. The arms may engage portions in a mechanical interlocking arrangement. The inner central rim may further include plates that, along with the arms may sandwich the portions of the spoke structure and create a further frictional and/or adhesive securement between the inner central rim and the spoke structure. The spoke structure may comprise a homogenous or heterogeneous polymer and/or a filled polymer.

Spokes of the spoke structure may be curved inwardly or outwardly for mitigating or enhancing buckling of the spokes. The spokes may include one or more reinforcing layers. The layer(s) may be constructed of single end dipped cords, conventional pneumatic tire ply/cord arrangements, short fibers, and/or polymeric film. Further, these constructions may be PET, nylon 6, nylon 6,6, rayon, steel, glass fibers, carbon fiber, aramid, and/or a hybrid construction of these materials. The cords may be from 400 denier to 9000 denier. The polymeric film may be from 0.1 mm to 2.0 mm thick. The spokes may be oriented at angle between 0 degrees and 90 degrees. The reinforcement of the spokes may be continuously reinforced across their entire axial length. Continuous reinforcement layer(s) may extend radially outward to multiple locations adjacent to a shear band at the outer flexible ring.

Each cavity may have a common cross-sectional profile about the axis of rotation of the assembly. Further, each cavity may have a common axial length equal to a uniform axial thickness of the spoke structure. Each cavity may be curvedly shaped to prevent “pinch” points on the reinforcement layer(s) and mitigate compressive stress concentrations on the reinforcement layer(s). The number of cavities may be between 2 and 60 for large scale tire assemblies. The inner central rim may include steel, cast iron, aluminum, aluminum alloys, magnesium allows, and/or iron alloys.

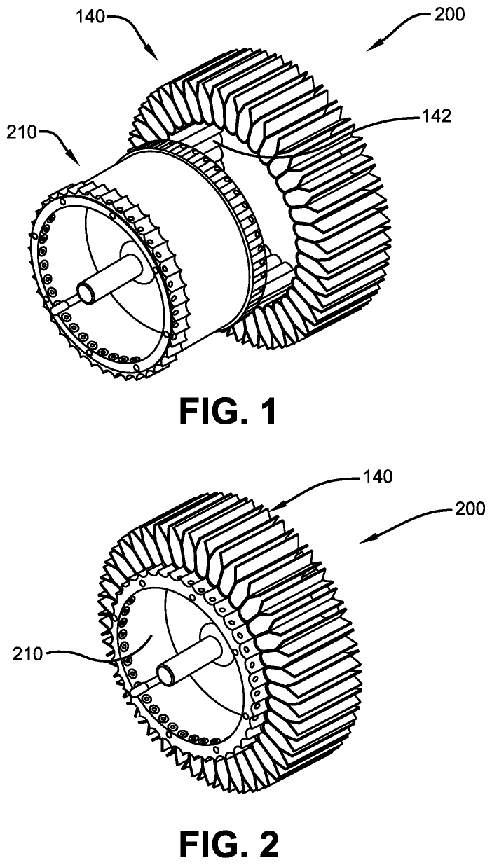

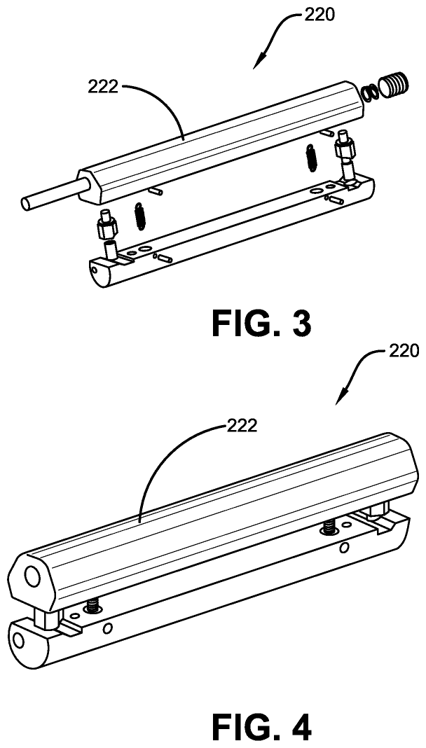

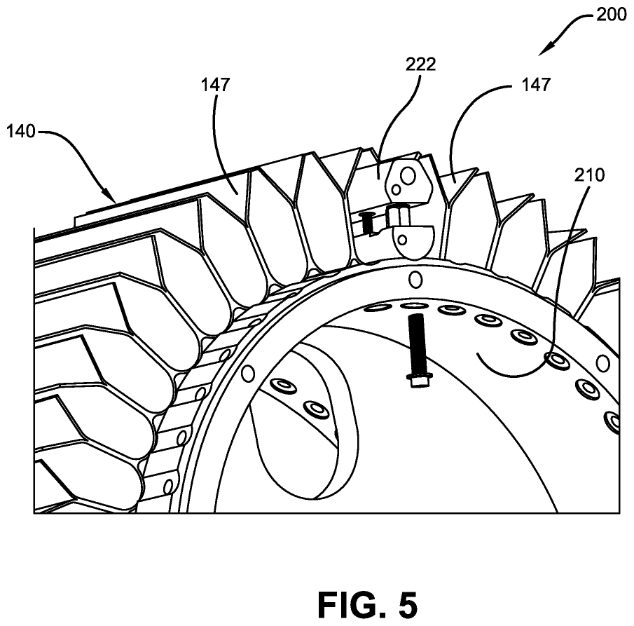

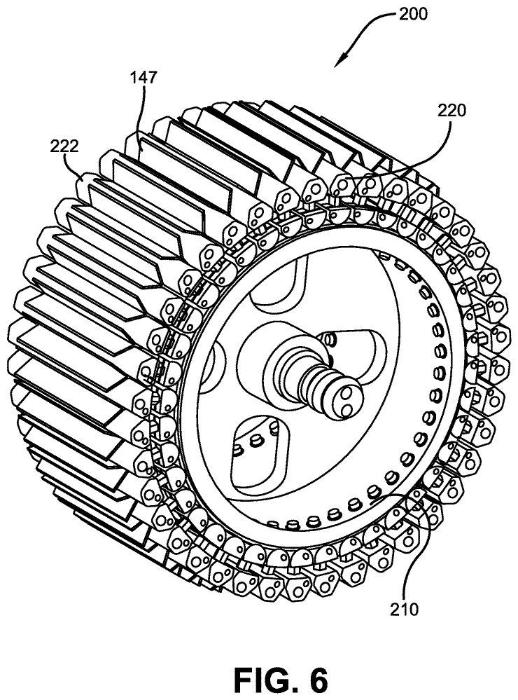

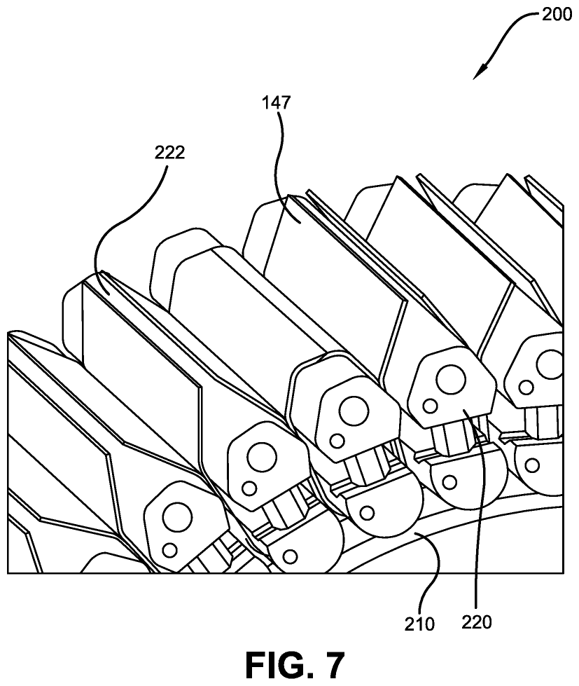

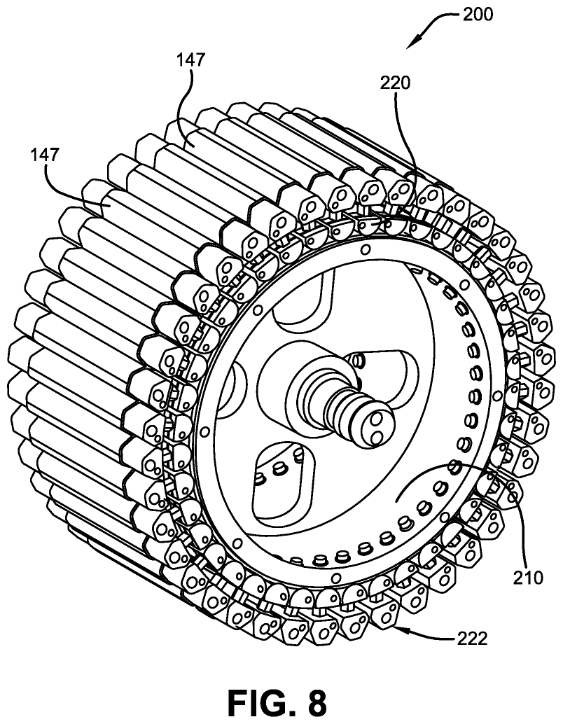

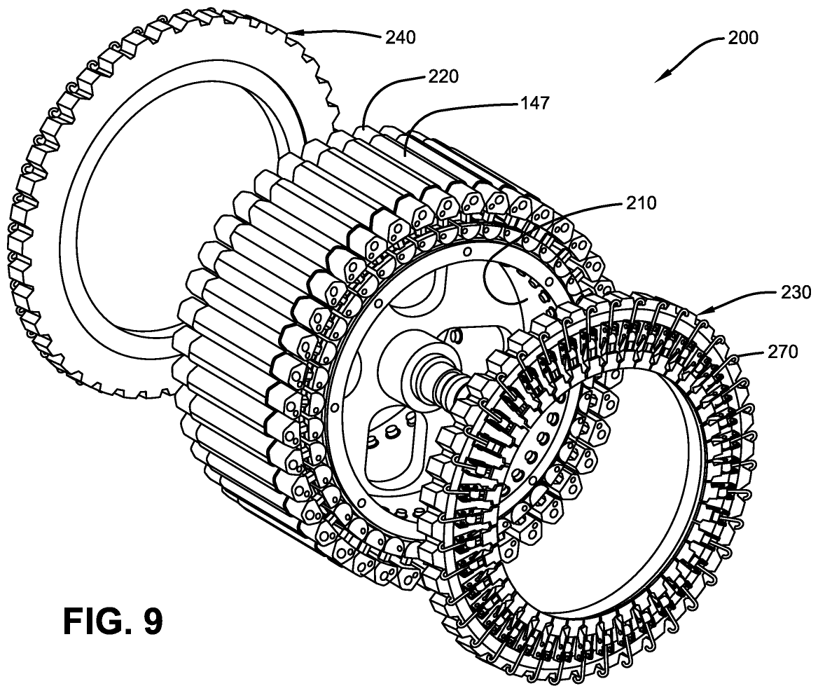

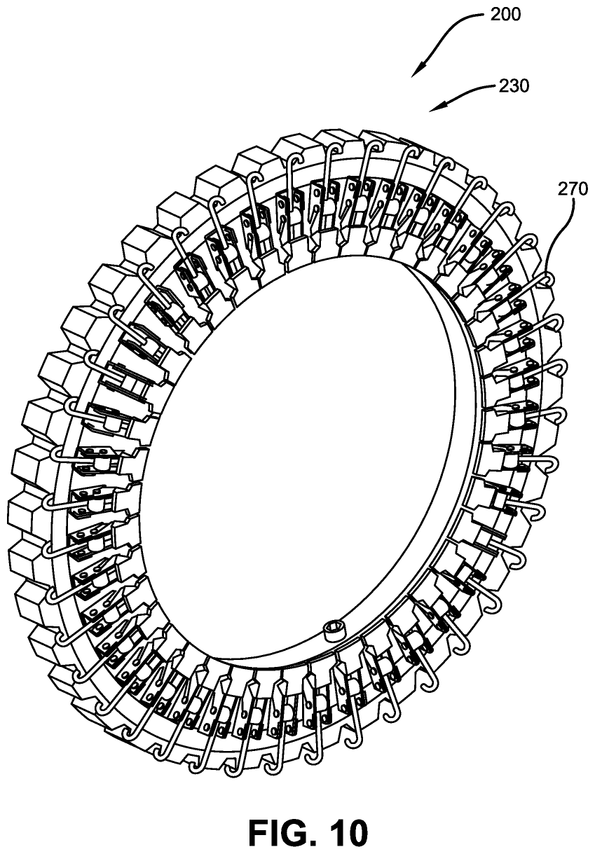

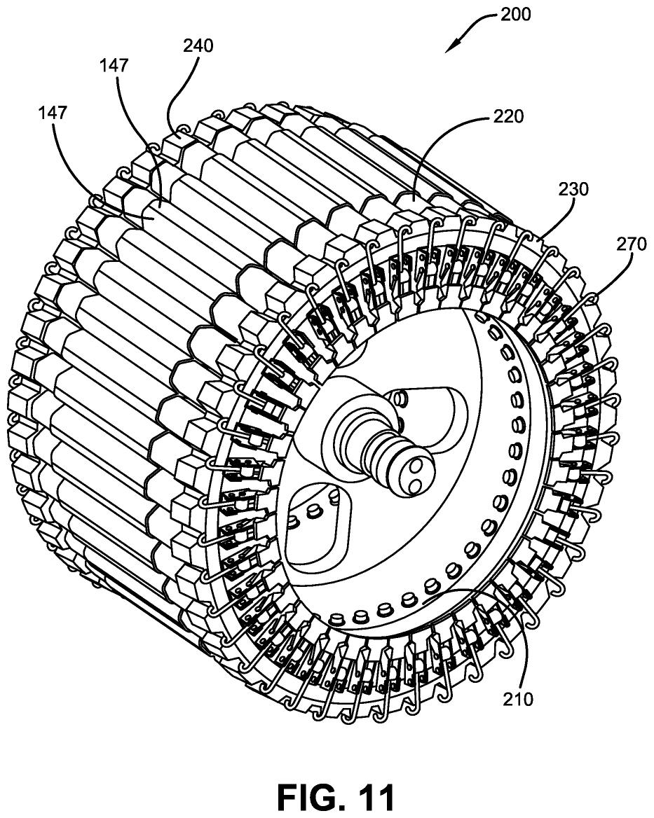

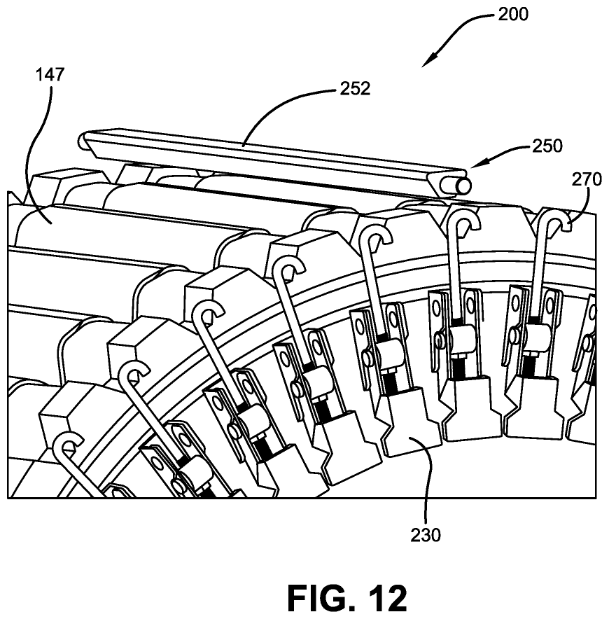

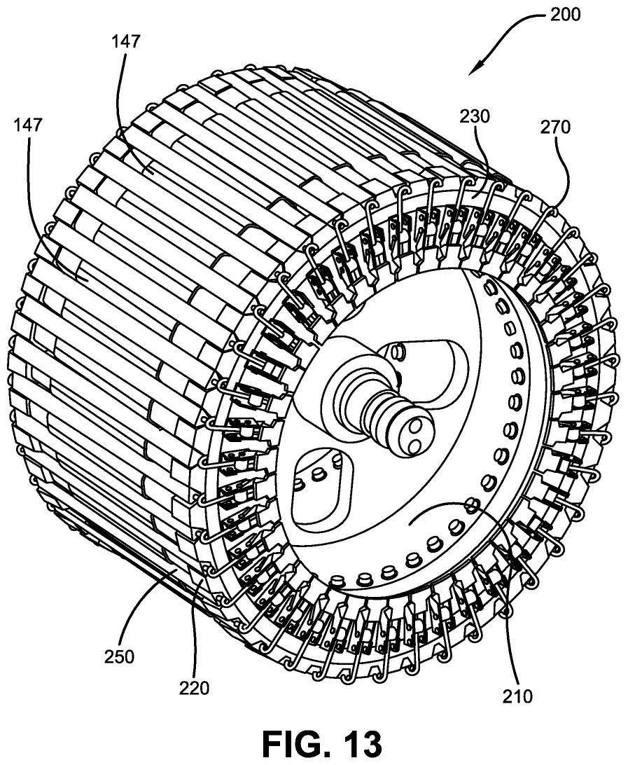

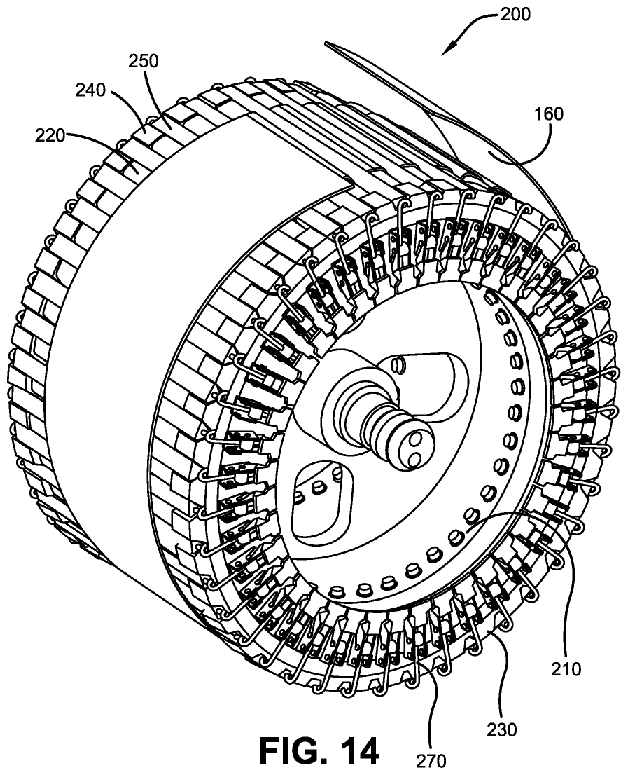

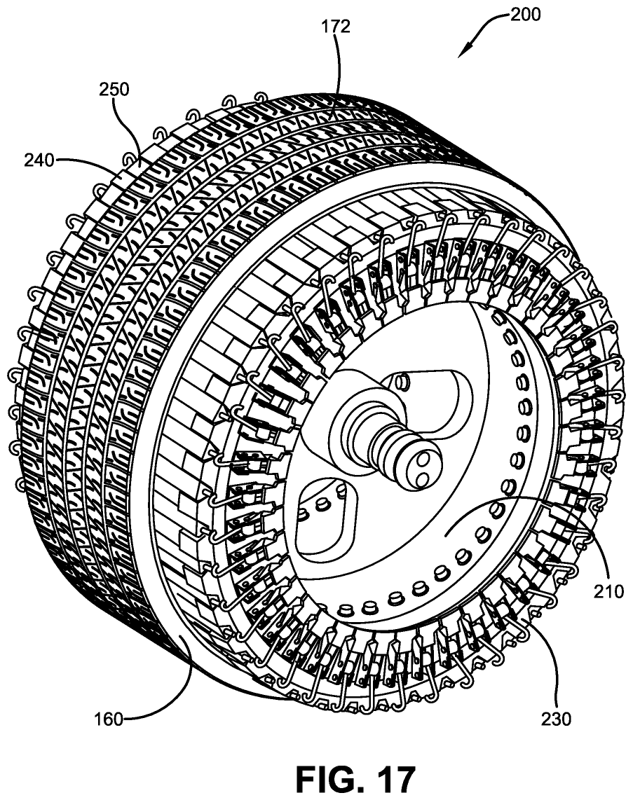

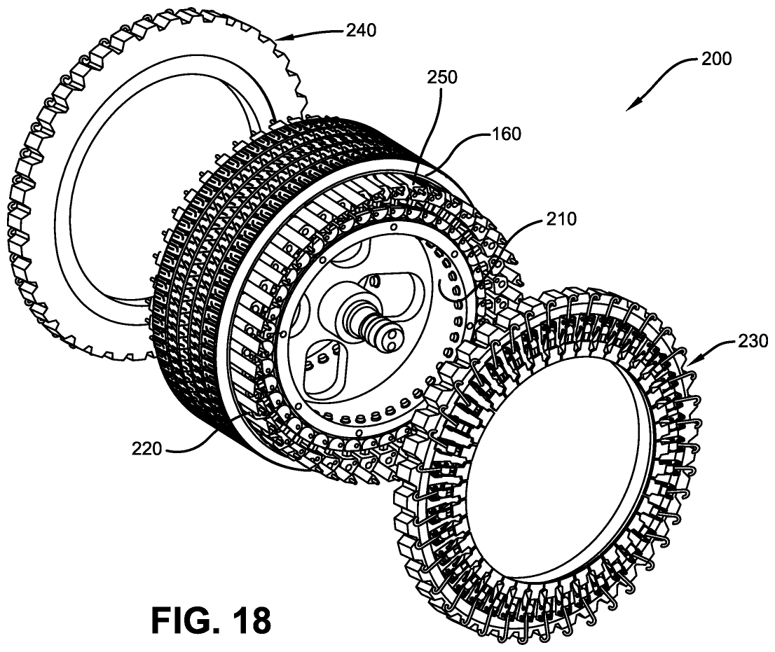

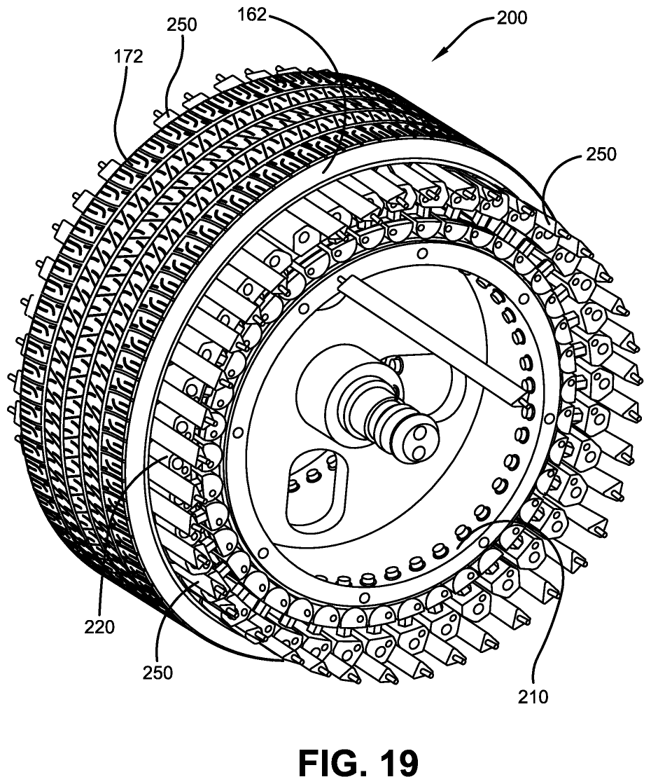

FIGS. 1-22 show a system 200 in accordance with the present invention for curing and manufacturing partially-cured pneumatic and/or non-pneumatic tire assemblies 140. The system 200 may include an annular hub member 210 slid into a corresponding annular, radially inner surface 142 of the tire assembly 140, a plurality of spacer members 220 for maintaining corresponding uniform cavity dimensions in the tire assembly 140 by fastening the spacer members 220 to the hub member 210 with flap members 147 of the tire assembly 140 enclosing a radially outermost surface 222 of each of the spacer members 220, first and second curing platens 230, 240 for axially securing the hub member 210 and spacer members 220 relative to each other, and a plurality of triangular inserts 250 for creating a substantially smooth, uniform outer cylindrical surface formed by a radially outer surface 252 of each triangular insert 250 and each of the flap members 147 of the tire assembly 140 positioned by the radially outermost surfaces 222 of the spacer members 220. The curing platens 230, 240 may also have spring hook members 270 for maintaining alignment with the spacer members 220 and the remaining parts of the assembly 200.

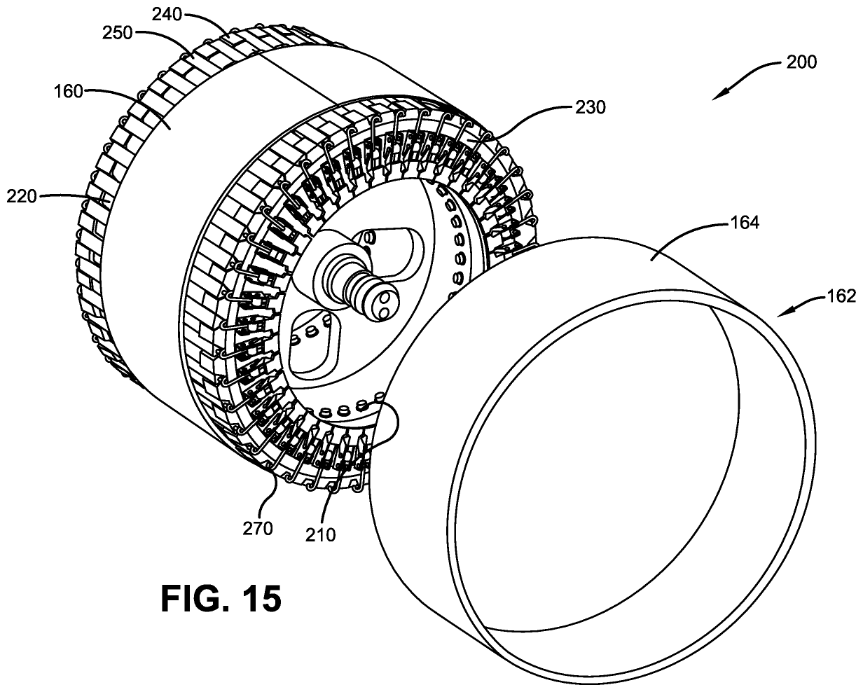

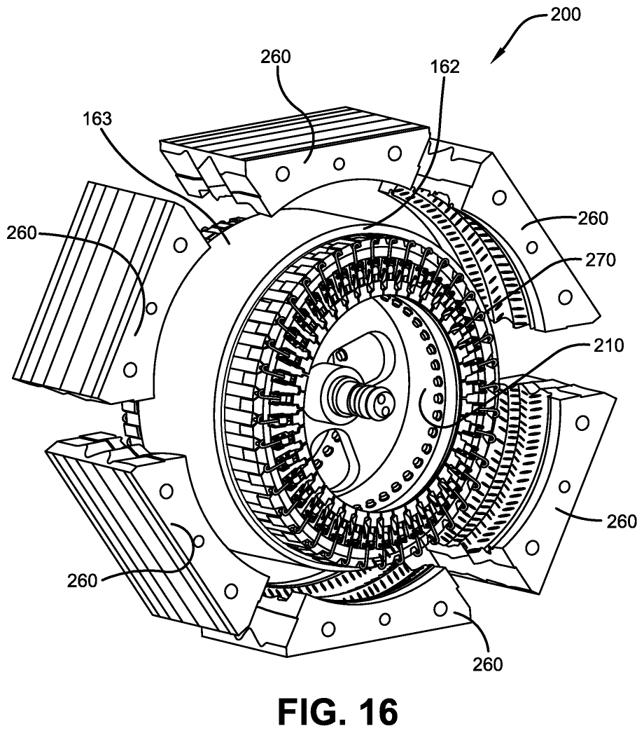

An inner annular shear band 160 and an outer annular tread member 162 of the tire assembly 140 may be serially placed circumferentially around the uniform outer cylindrical surface 147, 252 and affixed at least temporarily thereto and to each other 160, 162. This may be accomplished by building up layers 160, 162 around the assembly 200 similar to a conventional tire building method (not shown) or by forming a complete annular band structure from the shear band 160 and the tread member 162 (FIG. 15). A plurality of mold members 260 (six shown in FIG. 16) may be placed circumferentially around a radially outer surface 163 of the tread member 162. The mold members 260 may have radially inner surfaces 262 for together forming a tread shaped outer surface in the outer surface 163 of the tread member 162.

The spacer members 220, curing platens 230, 240, triangular inserts 250, and mold members 260 may be heated in order to cure form the flap members 147, shear band 160, and tread member 162 (e.g., uncured parts of the tire assembly 140) into a molded integral part of a complete, cured tire assembly 170 having an appropriate tread 172 (FIG. 21). Once curing is complete, the mold members 260 may be radially removed from around the complete tire assembly 170, the curing platens 230, 240 may axially removed from the hub member 210, and the spacer members 220 and inserts 250 may be axially withdrawn from the tire assembly 170 to reveal stable cavities 176 within a spoke structure 174 of the mount-ready tire assembly 170.

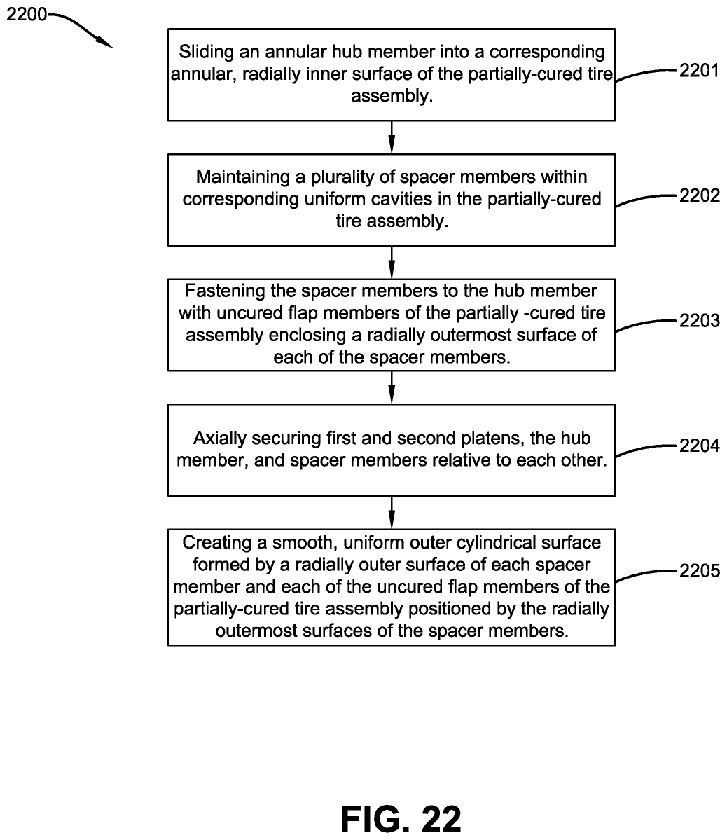

As shown in the FIG. 22, a method 2200, in accordance with the present invention, may cure and manufacture a partially-cured tire assembly 140 into a completed, “ready-to-install”, completely cured tire assembly 170. The method 2200 may include: a first step 2201 of sliding an annular hub member 210 into a corresponding annular, radially inner surface 142 of the partially-cured tire assembly 140; a second step 2202 of maintaining a plurality of spacer members 220 within corresponding uniform cavity dimensions in the partially-cured tire assembly 140; a third step 2203 of fastening the spacer members 220 to the hub member 210 with flap members 147 of the partially-cured tire assembly 140 enclosing a radially outermost surface 222 of each of the spacer members 220; a fourth step 220 of axially securing first and second curing platens 230, 240, the hub member 210, and spacer members 220 relative to each other; a fifth step 2205 of utilizing a plurality of triangular inserts 250 for creating a substantially smooth, uniform outer cylindrical surface formed by a radially outer surface 252 of each spacer member 250 and each of the flap members 147 of the partially-cured tire assembly 140 positioned by the radially outermost surfaces 222 of the spacer members 220; a sixth step 2206 of serially placing an uncured inner annular shear band 160 and an uncured outer annular tread member 162 of the partially-cured tire assembly 140 circumferentially around the uniform outer cylindrical surface 147, 252; a seventh step 2207 of affixing at least temporarily the uncured inner annular shear band 160 and the uncured outer annular tread member 162 of the partially-cured tire assembly 140 to each other 160, 162; an eighth step 2208 of placing a plurality of mold members 260 circumferentially around a radially outer surface 163 of the tread member 162; and a ninth step 2209 of forming a tread shaped outer surface in the outer surface 163 of the tread member 162 by radially inner surfaces 262 of the mold members.

The method 2200 may further include a tenth step 2210 of heating (e.g., by a hot liquid, steam, electricity, etc.) the spacer members 220, curing platens 230, 240, triangular inserts 250, and mold members 260 in order to cure/form the flap members 147, shear band 160, and tread member 162 (e.g., uncured parts of the partially-cured tire assembly 140) into a molded integral part of a complete, cured tire assembly 170 having an appropriate tread 172; an eleventh step 2211 of radially removing the mold members 260 from around the complete, fully-cured tire assembly 170; a twelfth step 2212 of axially removing the curing platens 230, 240 from the hub member 210; and a thirteenth step 2213 of axially withdrawing the spacer members 220 and inserts 250 from the fully-cured tire assembly 170 to reveal stable cavities 176 within a spoke structure 174 of the rim-mountable, fully-cured tire assembly 170.

Variations in the present invention are possible in light of the description of it provided herein. While certain representative examples and details have been shown for the purpose of illustrating the present invention, it will be apparent to those skilled in this art that various changes and/or modifications may be made therein without departing from the scope of the present invention. It is, therefore, to be understood that changes may be made in the particular examples described herein, which will be within the full scope of the present invention as defined by the following appended claims. Further, the present invention is not limited to the examples hereinbefore described, which may be varied in construction and/or detail within the full scope of the appended claims.

What is claimed:

1. A system for curing and manufacturing a partially-cured tire assembly, the system comprising:
an annular hub member slid into a corresponding annular, radially inner surface of the partially-cured tire assembly;
a plurality of elongate spacer members for maintaining corresponding uniform cavity dimensions in the partially-cured tire assembly tire assembly by fastening the spacer members to the hub member with flap members of the partially-cured tire assembly thereby enclosing a radially outermost surface of each of the spacer members;
a first annular curing platen for axially securing the hub member and spacer members relative to each other;
a second annular curing platen for axially securing the hub member and spacer members relative to each other; and
a plurality of elongate inserts for creating a substantially smooth, uniform outer cylindrical surface formed by a radially outer surface of each insert and flap members of the tire assembly positioned by the radially outermost surfaces of the spacer members.

2. The system as set forth in claim 1 further including a plurality of mold members placed circumferentially around a radially outer surface of a tread member.

3. The system as set forth in claim 2 wherein radially inner surfaces of the mold members together form a tread shaped outer surface in the radially outer surface of the tread member.

4. The system as set forth in claim 3 wherein the spacer members, first and second curing platens, triangular inserts, and mold members are heated in order to cure form the flap members, a shear band, and a tread member into a molded integral part of a complete, cured tire assembly.

5. The system as set forth in claim 1 wherein the elongate inserts have a triangular cross-section.

6. The system as set forth in claim 4 wherein the mold members are radially removable from around the complete, cured tire assembly.

7. The system as set forth in claim 1 wherein the curing platens are axially removable from the hub member, the elongate spacer members, and elongate inserts.

8. The system as set forth in claim 1 wherein the curing platens are heated by a hot liquid.

9. The system as set forth in claim 1 wherein the elongate spacer members platens are heated by steam.

10. The system as set forth in claim 1 wherein the elongate inserts are heated by electricity.

11. A method for completing the curing of a partially cured tire assembly, the method comprising the steps of:
sliding an annular hub member into a corresponding annular, radially inner surface of the partially-cured tire assembly;
maintaining a plurality of spacer members within corresponding uniform cavities in the partially-cured tire assembly;
fastening the spacer members to the hub member with uncured flap members of the partially-cured tire assembly enclosing a radially outermost surface of each of the spacer members;
axially securing first and second curing platens, the hub member, and spacer members relative to each other; and
creating a substantially smooth, uniform outer cylindrical surface formed by a radially outer surface of each spacer member and each of the uncured flap members of the partially-cured tire assembly positioned by the radially outermost surfaces of the spacer members.

12. The method as set forth in claim 11 further including a step of serially placing an uncured inner annular shear band and an uncured outer annular tread member of the partially-cured tire assembly circumferentially around the uniform outer cylindrical surface.

13. The method as set forth in claim 12 further including a step of affixing the uncured inner annular shear band and the uncured outer annular tread member of the partially-cured tire assembly to each other.

14. The method as set forth in claim 12 further including a step of placing a plurality of mold members circumferentially around a radially outer surface of the tread member.

15. The method as set forth in claim 14 further including a step of forming a tread shaped outer surface in the outer surface of the tread member by radially inner surfaces of the mold members.

16. The method as set forth in claim 15 further including a step of heating the spacer members, curing platens, elongate inserts, and mold members in order to form the flap members, shear band, and tread member into a fully-cured tire assembly.

17. The method as set forth in claim 16 further including a step of radially removing the mold members from around the fully-cured tire assembly.

18. The method as set forth in claim 17 further including a step of axially removing the curing platens from the hub member 210.

19. The method as set forth in claim 18 further including a step of axially withdrawing the spacer members and inserts from the fully-cured tire assembly to reveal stable cavities within a spoke structure of a rim-mountable, fully-cured tire assembly.

20. The method as set forth in claim 16 wherein the heating step includes a medium from the group consisting of a hot liquid, steam, and electricity.
